(19) United States
(12) Patent Application Publication
(10) Pub. No.: US 2013/0194456 A1
(43) Pub. Date: Aug. 1, 2013

(54) IMAGING DEVICE

(71) Applicant: Panasonic Corporation, Osaka (JP)

(72) Inventor: Mitsuo Abe, Osaka (JP)

(73) Assignee: Panasonic Corporation, Osaka (JP)

(21) Appl. No.: 13/749,711

(22) Filed: Jan. 25, 2013

(30) Foreign Application Priority Data
Feb. 1, 2012 (JP) 2012-019487

(51) Int. Cl. H04N 5/272

(52) U.S. Cl. CPC H04N 5/272
USPC 348/239

(57) ABSTRACT

An imaging device comprises a combination imaging mode. In combination imaging mode, recording-use image data is produced by capturing and combining a plurality of sets of image data. The imaging device further comprises a controller. The controller selects at least one set of image data from the plurality of sets of image data when it is determined in the combination imaging mode that the plurality of sets of image data are image data that do not satisfy a specific condition. The controller also produces the recording-use image data based on the one or more sets of image data.

### CROSS-REFERENCE TO RELATED APPLICATIONS

This application claims priority under 35 U.S.C. §119 to Japanese Patent Application No. 2012-019487 filed on Feb. 1, 2012. The entire disclosure of Japanese Patent Application No. 2012-019487 is hereby incorporated herein by reference.

### BACKGROUND

1. Field of the Invention

The present disclosure relates to an imaging device with which a plurality of sets of captured image data can be combined to produce a single set of image data.

2. Description of the Related Art

Digital cameras comprise a sequential combination function in recent years. This sequential combination function produces a single image by combining a plurality of images sequentially. For example, Patent Literature H8-214211 discloses a method for producing a single image with a wide dynamic range. This image is produced by combining a plurality of images captured at different exposure settings in an environment with a high contrast, such as when photographing a backlit subject. Image processing whose purpose is to expand the dynamic range is called high dynamic range imaging (hereinafter referred to as HDR imaging). The user can select sequential image processing mode (combination processing mode) as one of the imaging modes of the digital camera.

### SUMMARY

With the above-mentioned conventional digital camera, a problem encountered in sequential image processing such as HDR imaging was that if the sequential image processing failed, then this photograph (image) is recorded as a failed photograph (image). For example, if the subject moved while a plurality of images were being sequentially captured, then there was the risk that the subject would be blurred in the processed image and a failed photograph would be produced

It is an object of the present disclosure to reduce the likelihood of obtaining failed photographs with an imaging device capable of sequential image processing.

The imaging device in this disclosure comprises a combination imaging mode. In combination imaging mode, recording-use image data is produced by capturing and combining a plurality of sets of image data. The imaging device further comprises a controller. The controller selects at least one set of image data from the plurality of sets of image data when it is determined in the combination imaging mode that the plurality of sets of image data are image data that do not satisfy a specific condition. The controller also produces the recording-use image data based on the one or more sets of image data.

With the imaging device in this disclosure, the likelihood of obtaining failed photographs in sequential image processing can be reduced.

### BRIEF DESCRIPTION OF DRAWINGS

FIG. 1 is a front view of a digital camera pertaining to an embodiment;

FIG. 2 is a rear view of the digital camera pertaining to this embodiment;

FIG. 3 is a block diagram of the digital camera pertaining to this embodiment;

FIG. 4 is a flowchart of the processing of the digital camera in imaging mode in this embodiment; and

FIG. 5 is a flowchart of the processing of the digital camera in imaging mode in another embodiment.

### DETAILED DESCRIPTION OF THE INVENTION

Selected embodiments will be described through reference to the drawings. In the following description of the drawing, the same or similar parts will be given the same or similar numbers. The drawings are only schematics, however, and the dimensional proportions therein may differ from the actual ones. Therefore, the specific dimensions and so forth should be determined by referring to the following description. Also, the dimensional relations and proportions may of course vary from one drawing to the next. It will be apparent to those skilled in the art from this disclosure that the following descriptions of the embodiments are provided for illustration only and not for the purpose of limiting the invention as defined by the appended claims and their equivalents.

In the following embodiment, a digital camera will be described as an example of an imaging device. Also, in the following description, using the normal orientation of the digital camera (hereinafter also referred to as the landscape orientation) as a reference, the direction facing the subject is defined as “forward,” the direction away from the subject as “rearward,” vertically upward as “upward,” vertically downward as “downward,” to the right in a state of directly facing the subject as “to the right,” and to the left in a state of directly facing the subject as “to the left.”

### 1. Embodiment

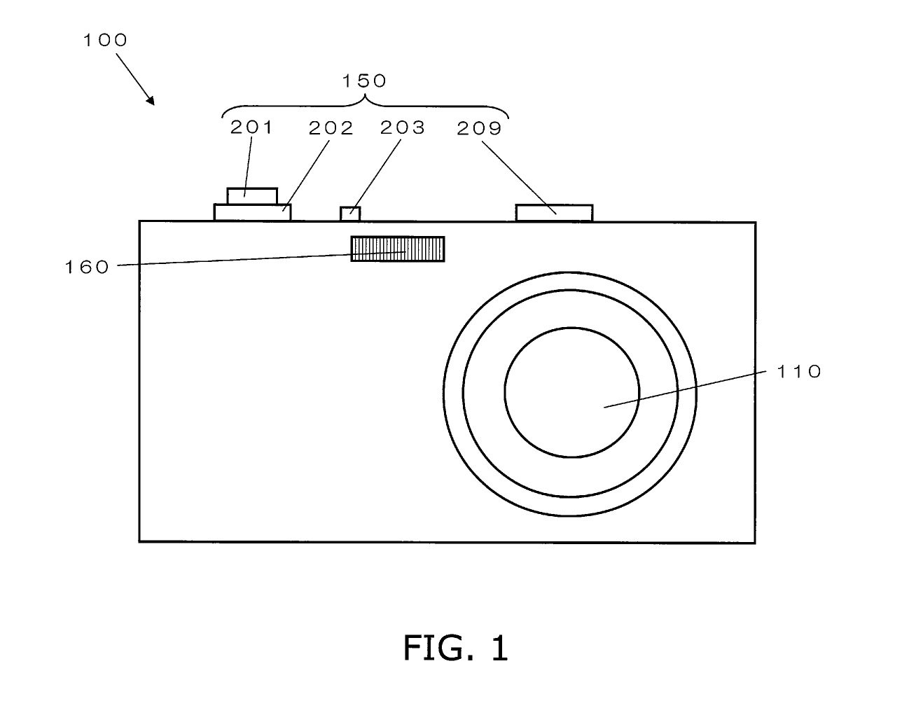

A digital camera 100 (an example of an imaging device) pertaining to this embodiment will now be described through reference to FIGS. 1 to 4. The digital camera 100 is an imaging device capable of capturing both moving and still pictures.

1-1. Configuration of Digital Camera

FIG. 1 is a front view of a digital camera pertaining to this embodiment. As shown in FIG. 1, the digital camera 100 comprises on its front face a lens barrel that houses an optical system 110, and a flash 160. A manipulation unit 150 is provided to the top face of the digital camera 100. The manipulation unit 150 includes a still picture release button 201, a zoom lever 202, a power button 203, a scene dial 209, and so forth.

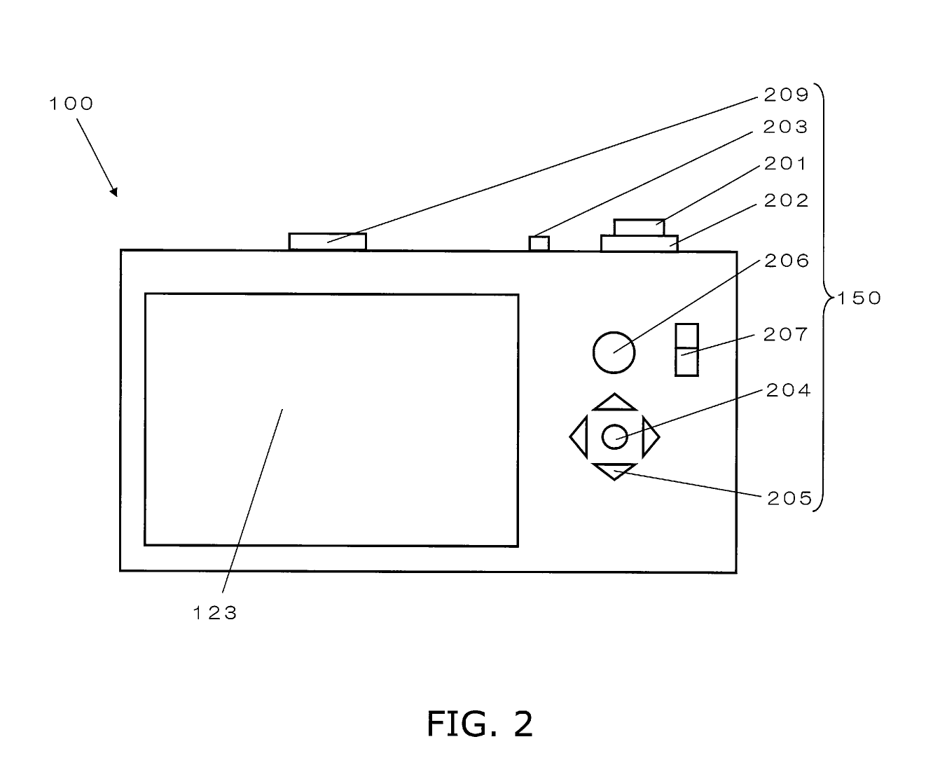

FIG. 2 is a rear view of the digital camera pertaining to this embodiment. As shown in FIG. 2, a manipulation unit 150 is provided to the rear face of the digital camera 100. The manipulation unit 150 includes a liquid crystal monitor 123, a center button 204, a cross button 205, a moving picture release button 206, a mode switch 207, and so forth.

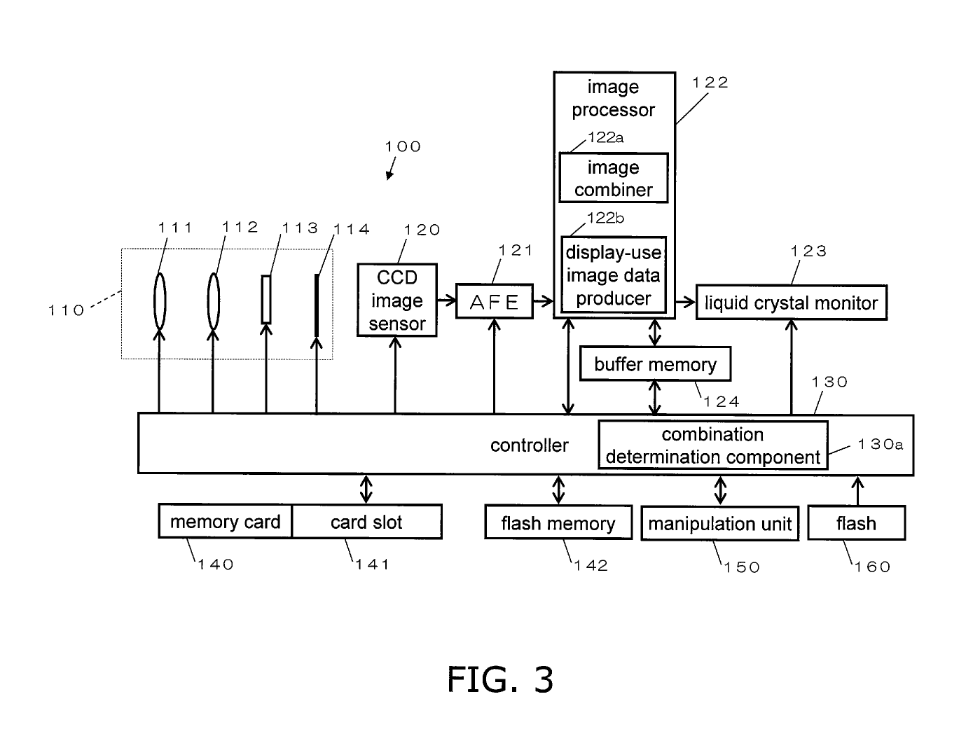

FIG. 3 is a block diagram of the digital camera pertaining to this embodiment. As shown in FIG. 3, the digital camera 100 comprises the optical system 110, a CCD image sensor 120, an AFE (analog front end) 121, an image processor 122, a buffer memory 124, the liquid crystal monitor 123, a controller 130, a card slot 141, a memory card 140, a flash memory 142, the manipulation unit 150, and the flash 160.

The optical system 110 forms a subject image. The optical system 110 may include a focus lens 111, a zoom lens 112, an aperture 113, and a shutter 114. In another embodiment, the optical system 110 may include an optical blur correcting lens OIS (optical image stabilizer). The optical system 110 may be made up of any number of lenses, and may be made up of any number of lens groups.

The focus lens 111 is used to adjust the focal state of the subject. The zoom lens 112 is used to adjust the field angle of the subject. The aperture 113 adjusts the amount of light that is incident on the CCD image sensor 120. The shutter 114 adjusts the exposure time for the light incident on the CCD image sensor 120. The focus lens 111, the zoom lens 112, the aperture 113, and the shutter 114 are each driven by a DC motor, a stepping motor, or another such drive unit, according to a control signal issued from the controller 130.

The CCD image sensor 120 is an imaging element that captures a subject image formed by the optical system 110. The CCD image sensor 120 produces frames of image data corresponding to a subject image.

The AFE (analog front end) 121 subjects the image data produced by the CCD image sensor 120 to various kinds of processing. More specifically, the AFE 121 performs noise suppression by correlated double sampling, amplification to the input range width of an A/D converter by analog gain controller, A/D conversion by A/D converter, and so forth.

The image processor 122 subjects the image data that has undergone various processing by the AFE 121 to various kinds of processing. The zoom lens 112 executes various processing on the image data. Examples of the various processing include smear correction, white balance correction, gamma correction, YC conversion processing, electronic zoom processing, compression processing, and expansion processing. The image processing unit 122 produces through-images and recorded images by executing this processing on the image data. In this embodiment, the image processor 122 is a hard-wired electronic circuit, but may instead be constituted integrally with the controller 130, etc.

The image processor 122 executes various processing on the image data in an image combiner 122a and a display-use image data producer 122b on the basis of a command from the controller 130. If a plurality of sets of image data is combined, then the image processor 122 instructs the image combiner 122a to combine the image data on the basis of a command from the controller 130. The processing performed by the image combiner 122a will be discussed in detail below.

The controller 130 controls the overall operation of the entire digital camera 100. The controller 130 is constituted by a ROM, a CPU, and so forth. The ROM stores an overall control program and individual control programs. An overall control program is a program for the overall control of the entire digital camera 100. An individual control program is a program related to file control, auto focus control (AF control), automatic exposure control (AE control), light emission control over the flash 160, and so on.

The controller 130 determines in a combination determination component 130a whether or not sequential image processing (an example of combination processing) of image data has succeeded in the image combiner 122a. The processing performed by the combination determination component 130a will be described in detail below.

The controller 130 records image data that has undergone various processing by the image processor 122, as still picture data or moving picture data to the memory card 140 and the flash memory 142 (hereinafter referred to as “the memory card 140, etc.”). The controller 130 is a microprocessor that executes programs, but may instead be a hard-wired electronic circuit. The controller 130 may also be configured integrally with the image processor 122, etc.

The liquid crystal monitor 123 displays through-images, recorded images, and so forth. These through-images and recorded images are produced by the image processor 122. A through-image is a series of images which are produced continuously at specific time intervals while the digital camera 100 is set to imaging mode. More precisely, sequential image data corresponding to a series of images is produced at specific time intervals by the CCD image sensor 120. The user can capture an image while checking the composition of the subject by referring to the through-image displayed on the liquid crystal monitor 123.

A recorded image is an image obtained by decoding (expanding) still picture data or moving picture data that has been recorded to the memory card 140, etc. When the digital camera 100 is in reproduction mode, a recorded image is displayed on the liquid crystal monitor 123. In another embodiment, some other display capable of displaying images, such as an organic EL display, may be used instead of the liquid crystal monitor 123.

The buffer memory 124 is a volatile memory medium that functions as a working memory for the image processing unit 122 and the controller 130. In this embodiment, the buffer memory 124 is a DRAM.

The flash memory 142 is an internal memory of the digital camera 100. The flash memory 142 is a nonvolatile recording medium. The flash memory 142 has a customized category registration region and a current value holding region (not shown).

The memory card 140 can be removably inserted into the card slot 141. The card slot 141 is electrically and mechanically connected to the memory card 140.

The memory card 140 is an external memory of the digital camera 100. The memory card 140 is a nonvolatile recording medium.

The manipulation unit 150 is a manipulation interface that is operated by the user. The manipulation unit 150 refers collectively to control buttons, control dials, and so forth which are provided to the exterior of the digital camera 100. The manipulation component 150 includes the still picture release button 201, the moving picture release button 206, the zoom lever 202, the power button 203, the center button 204, the cross button 205, the mode switch 207, and the scene dial 209. The manipulation component 150 sends signals corresponding to operational commands to the controller 130 when operated by the user.

The still picture release button 201 is a push button that is used to instruct the timing of still picture recording. The moving picture release button 206 is a push button that is used to instruct the timing of the start and end of moving picture recording. The controller 130 instructs the image processor 122, etc., to produce still picture data or moving picture data at the timing when the release button 201 or 206 is pressed. The still picture data or moving picture data produced here is stored in the memory card 140, etc.

The zoom lever 202 is used to adjust the field angle between the wide angle end and the telephoto end. The controller 130 drives the zoom lens 112 according to operation of the zoom lever 202 by the user.

The power button 203 is a slide button for switching the supply of power on and off to the various components of the digital camera 100.

The center button 204 and the cross button 205 are push buttons. The user can operate the center button 204 and the cross button 205 to display various screens (including a setting menu screen and a quick setting menu screen (not shown)) on the liquid crystal monitor 123. The user can set the setting category values related to various conditions for imaging and reproduction on these setting screens.

The mode switch 207 is a slide switch for switching the digital camera 100 between imaging mode and reproduction mode.

The scene dial 209 is used to switch the scene mode. “Scene mode” is the collective term for modes set according to imaging conditions. Factors that affect imaging conditions include the subject and the imaging environment, and so on. The scene dial 209 is used to set one of a plurality of scene modes.

The scene modes include, for example, landscape mode, portrait mode, nighttime mode, and backlit mode. For example, the portrait mode is suited to capturing an image so that the skin tone of a person has the proper hue. Backlit mode is suited to imaging in an environment with a high contrast. Backlit mode is an example of a mode in which sequential image processing is performed.

1-2. Operation in Imaging Mode

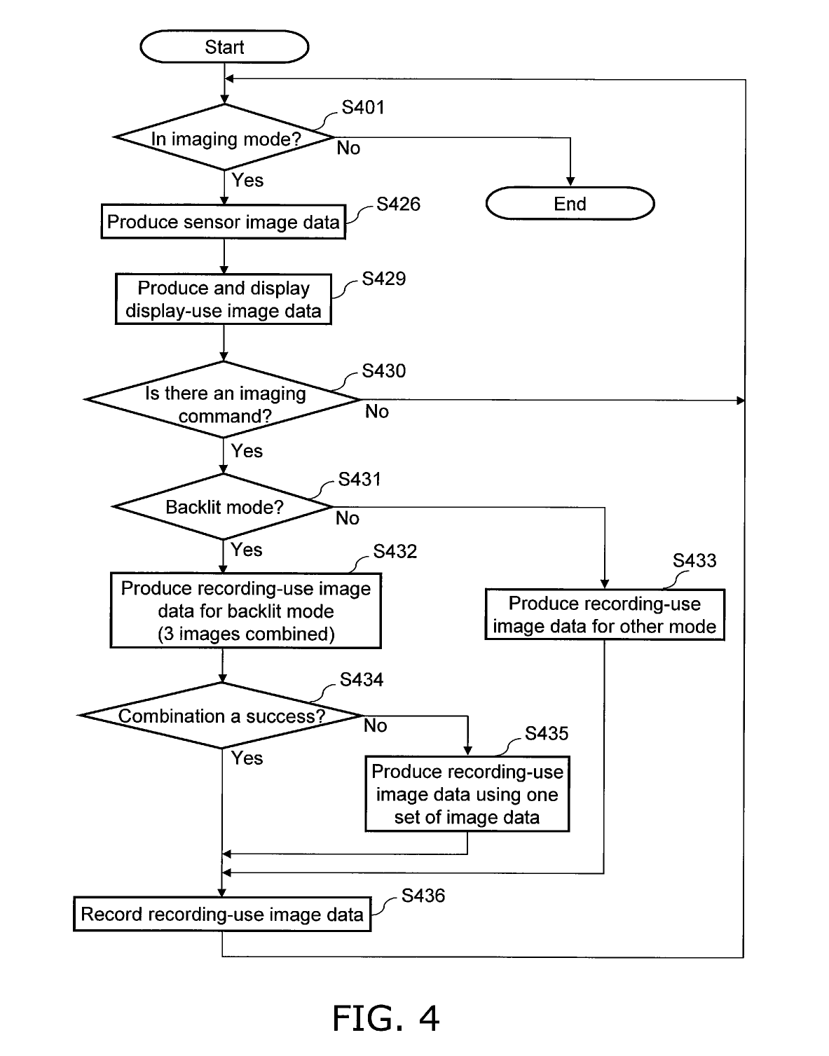

FIG. 4 is a flowchart of the processing of the digital camera in imaging mode. The operation in imaging mode will now be described through reference to FIG. 4.

When the user presses the power button 203 to switch on the power to the digital camera 100, the controller 130 refers to the setting of the mode switch 207 (S401). More precisely, the controller 130 determines whether the setting of the mode switch 207 is imaging mode or reproduction mode. If the mode switch 207 has been set to reproduction mode (No in S401), the controller 130 ends processing related to imaging mode.

If the mode switch 207 has been set to imaging mode (Yes in S401), the controller 130 goes into an imaging standby state in imaging mode. In this state, the controller 130 performs imaging operations corresponding to the scene mode according to the imaging instruction from the user.

The scene mode is described below. A scene mode is selected from among a plurality of scene modes registered in the digital camera 100. For instance, the user operates the manipulation unit 150 to select a scene mode. The scene mode selected here is recognized by the controller 130. More specifically, a scene mode is selected from among landscape mode, portrait mode, nighttime mode, backlit mode, and so forth by the user and the scene mode is recognized by the controller 130.

The controller 130 recognizes image data produced by the CCD image sensor 120 (sensor image data) (S426). The image processor 122 then subjects the sensor image data to processing corresponding to the scene mode set by the controller 130. As a result of this processing, the image processor 122 produces display-use image data. A through-image is then displayed on the liquid crystal monitor 123 on the basis of this display-use image data (S429).

If the controller 130 at this point has not detected that the user has pressed the still picture release button 201 (No in S430), the controller 130 goes back to step S401 and repeats the processing from there. On the other hand, if the user has pressed the still picture release button 201 (Yes in S430); the controller 130 detects the pressed state of the still picture release button 201 (Yes in S430). At this point the controller 130 refers to the scene mode set with the manipulation unit 150 (S431). A case in which the scene mode is backlit mode will not be described in detail, but we will assume that processing according to the various scene modes is executed for other scene modes as well.

If the scene mode is backlit mode (Yes in S431), the controller 130 performs processing to produce recording-use image data in backlit mode (S432). The controller 130 produces recording-use image data for backlit mode by sequential image processing, More precisely, in sequential image processing, the controller 130 acquires three sets of image data with different exposures and combines them, thereby producing recording-use image data for backlit mode (one set of image data).

When sequential image processing is performed in an environment with high contrast, the more sets of image data there are with different exposures, the better an image can be produced. On this image, a wide range from dark to bright can be reproduced in more natural colors. In this embodiment, a case that three images are combined with different exposures is shown below.

First, the controller 130 actuates the optical system 110 to acquire one set of image data (first image data). In this case, the controller 130 issues a command to the optical system 110 so that the image is under-exposed. When the imaging operation is performed at this setting, the first image data is produced so that relatively bright regions in the image are close to the proper exposure. Since the first image data is image data captured in an under-exposed state, the image data is darker overall than the second set of image data (second image data) and third set of image data (third image data). The image processor 122 subjects the first image data outputted from the AFE 121 to image processing suited to relatively bright regions in the image. The controller 130 then stores this first image data in the buffer memory 124.

The controller 130 then actuates the optical system 110 to acquire a second set of image data (second image data). In this case, the controller 130 issues a command to the optical system 110 so that the image exposure is in between under-exposed and over-exposed. When the imaging operation is performed at this setting, the second image data is produced so that regions of intermediate brightness in the image are close to the proper exposure. The image processor 122 subjects the second image data outputted from the AFE 121 to image processing suited to regions having intermediate brightness in the image. The controller 130 then stores this second image data in the buffer memory 124.

The controller 130 then actuates the optical system 110 to acquire a third set of image data (third image data). In this case, the controller 130 issues a command to the optical system 110 so that the image will be over-exposed. When the imaging operation is performed at this setting, third image data is produced so that relatively dark regions in the image are close to the proper exposure. Since this third image data is image data captured in an over-exposed state, the image data is brighter overall than the first image data and the second image data. The image processor 122 subjects the third image data outputted from the AFE 121 to image processing that is suited to relatively dark regions in the image. The controller 130 then stores this third image data in the buffer memory 124.

Finally, the image combiner 122a combines the three sets of image data stored in the buffer memory 124 (the first image data, second image data, and third image data) to produce recording-use image data.

The controller 130 (an example of the combination determination component 130a) then determines whether the sequential image processing has succeeded or failed (S434). More specifically, if the controller 130 determines that the subject is blurred in the recording-use image data produced by sequential image processing, then the controller 130 recognizes that the sequential image processing have failed. Whether or not there is blurring is determined on the basis of the distribution of high-frequency components (edges) included in the image data, for example. More specifically, the contour of the subject included in the image data is detected, and the success or failure of the sequential image processing is determined on the basis of blurring of this contour.

If the controller 130 determines that the sequential image processing has succeeded (Yes in S434), the produced recording-use image data is recorded to the memory card 140 in step S436 (discussed below).

If the controller 130 determines that the sequential image processing has failed (Yes in S434), the image processor 122 produces recording-use image data by using just one set of image data from among the three sets obtained (first image data, second image data, and third image data) (S435).

More specifically, the recording-use image data is produced by means of the following processing. First, the image processor 122 selects the first image data. The first image data is image data captured in an under-exposed state. In other words, the first image data is image data in which relatively bright regions in the image are close to the proper exposure.

Next, the image processor 122 subjects the first image data to image processing suited to relatively bright regions in the image. For example, the image processor 122 subjects the first image data to gradation conversion processing so that a subject in a relatively dark region is discerned. The image processor 122 then stores the processed first image data as recording-use image data in the buffer memory 124.

If the scene mode is something other than backlit mode (No in S431), the image processor 122 executes image processing suited to a scene mode other than backlit mode, and produces recording-use image data (S433). For example, if the mode is determined to be a portrait mode, recording-use image data is produced by performing image processing so that the skin tone of the person has the proper hue.

As discussed above, when recording-use image data corresponding to a scene mode is produced, the controller 130 executes processing to record the recording-use image data to the memory unit such as the memory card 140 (S436). After this, the controller 130 refers to the mode (imaging mode or reproduction mode) which is set with the mode switch 207 (S401). The above series of operations is repeated until the user either changes the mode switch 207 to reproduction mode (No in S401) or turns off the power.

1-3. Features

The digital camera 100 in this embodiment captures a plurality of sets of image data with different exposures and executes sequential image processing when the scene mode set by the user is backlit mode. Consequently, an image can be produced in which a wide range from dark to bright can be reproduced in more natural colors.

Also, with the digital camera 100, when it is determined that a failed photograph has been obtained by sequential image processing, recording-use image data is produced on the basis of one set of image data from among a plurality of sets of image data captured sequentially. Consequently, even in a situation in which a failed photograph would have been obtained by sequential image processing in the past, the likelihood that a failed photograph will be obtained can be reduced. Specifically, a photograph that is preferable to the user can be provided.

### 2. Other Embodiments

An embodiment of the present disclosure was described above, but the present technology is not limited to or by the above embodiment, and various changes are possible without departing from the gist of the disclosure. In particular, embodiments and modification examples given in this Specification can be combined as needed.

The following embodiments are examples of other embodiments.

(A) In the above embodiment, an example was given in which it was determined whether or not combination succeeded on the basis of the combined recording-use image data. Instead, image data that has not yet been combined may be used, and a determination as to whether or not the combination will succeed when these sets of data are combined may be executed. For example, the controller 130 calculates the extent (coincidence) to which edge portions of the sets of image data coincide, and predicts that combination will succeed when this coincidence is high.

In other words, if the controller 130 predicts that the contour of the primary subject does not blur, the controller 130 determines that the combination will succeed. Specifically, the movement vector of the edge portions of the various sets of image data is calculated, and it is determined that combination will succeed when the average magnitude of this movement vector is below a threshold value.

(B) In the above embodiment, an example was given in which the success or failure of sequential image processing was determined after the sequential image processing was executed, but instead, the success or failure of sequential image processing may be determined before executing the sequential image processing.

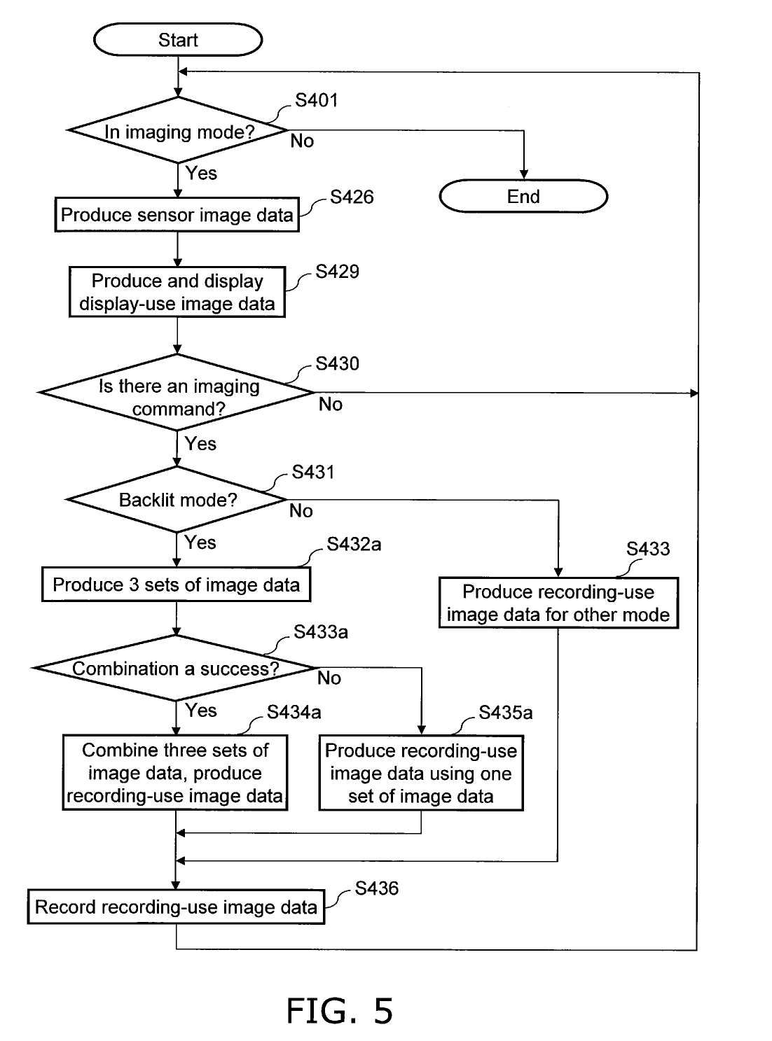

For example, as shown in FIG. 5, if the scene mode is backlit mode (Yes in S431), the controller 130 produces three sets of image data with different exposures (S432a). The controller 130 then predicts whether or not sequential image processing will succeed on the basis of these three sets of image data (S433a). The determination in (A) above is used here, for example. If the controller 130 predicts that the sequential image processing will be a success (Yes in S433a), then recording-use image data is produced by combining the three sets of image data (S434a). On the other hand, if the controller 130 predicts that the sequential image processing will fail (No in S433a), then recording-use image data is produced from one set of image data. The recording-use image data produced here is recorded to a recorder, such as the memory card 140 (S436).

In FIG. 5, processing that is the same as in the above embodiment is numbered the same. Also, processing that is the same as in the above embodiment will not be described again. Specifically, refer to the above embodiment for description that is omitted here.

(C) In the above embodiment, an example was given in which, if the sequential image processing was determined to have failed, recording-use image data was produced by performing image processing on one set of image data (first image data) among the three sets of image data. Instead, recording-use image data may be produced using other image data. For example, the recording-use image data may be produced by performing image processing on a second set of image data (second image data) or a third set of image data (third image data).

(D) In the above embodiment, when the user selected backlit mode as the scene mode, the recording-use image data was produced on the basis of a third set of image data in processing for producing recording-use image data in backlit mode (S432). In processing for producing recording-use image data in backlit mode, the exposure setting for the various sets of image data does not necessarily have to be over-exposure or under-exposure. Specifically, the exposure setting may be changed according to the environment of the subject. Also, the number of sets of image data during combination may be other than three.

(E) In the above embodiment, backlit mode was described as an example of a mode for performing sequential image processing, but as long as it is a mode that executes sequential image processing for producing and combining a plurality of sets of image data, any mode may be used. For instance, this technology can also be applied to handheld nighttime mode (imaging in a low-light environment). Handheld nighttime mode is a mode used for capturing an image at nighttime, and is suited to imaging in a low-light environment. In a low-light environment, the exposure time has to be increased in order to obtain the proper exposure. However, in a low-light environment, because the exposure time takes longer, it is very likely that camera shake will cause blurred image data to be obtained. In view of this, in handheld nighttime mode, a plurality of sets of image data (the individual sets of image data are usually under-exposed) are captured in a low-light environment at an exposure time that is short enough not to cause blurring. These images are combined to produce image data of the proper exposure. Thus, if handheld nighttime mode is selected, just as with backlit mode, sequential image processing and combination success determination processing are performed, and recording-use image data can be produced according to the determination result. This allows the same effect as above to be obtained.

(F) In the above embodiment, an example was given in which either landscape mode, portrait mode, nighttime mode, handheld nighttime mode, or backlit mode was clearly selected with the scene dial 209, but the scene dial 209 may additionally include an automatic scene determination mode. In automatic scene determination mode, one mode from among landscape mode, portrait mode, nighttime mode, handheld nighttime mode, and backlit mode is automatically set on the basis of the image data.

For example, with prior art, if backlit mode is automatically selected in automatic scene determination mode, a plurality of sets of image data are sequentially captured, and these sets of image data are combined. Here, if the subject moves during the sequential capture of the images, then a blurry image will be outputted as the combined image. That is, if backlit mode is automatically selected in automatic scene determination mode, the user may not understand why the resulting image is blurred.

With the present technique, on the other hand, even if the subject moves during the sequential capture of images when backlit mode has been automatically selected in automatic scene determination mode, an non-blurring image will be outputted due to the processing of step 434 (S434) and step 435 (S435), and the processing of step 433a (S433a) and step 435a (S435a). That is, with the present technique, a sharp image, which looks natural to the user, can be provided regardless of mode,

### INDUSTRIAL APPLICABILITY

The imaging device disclosed herein reduces the likelihood that a failed photograph will be obtained in sequential image processing. This disclosure can be widely utilized in imaging devices such as a digital still camera, digital video camera, portable telephone, smart phone, and the like.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of an imaging device. Accordingly, these terms, as utilized to describe the present invention should be interpreted relative to an imaging device.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An imaging device comprising:
a combination imaging mode configured to capture and combine a plurality of sets of image data to produce recording-use image data in the combination imaging mode; and
a controller configured to:
select at least one set of image data from among the plurality of sets of image data if it is determined that the plurality of sets of image data do not satisfy a specific condition in the combination imaging mode, and
to produce the recording-use image data based on at least one set of image data.

2. The imaging device according to claim 1, wherein:
the combination imaging mode is further configured to estimate at least one set of image data; and
the controller is further configured to:
select the at least one set of image data from among the plurality of sets of image data if the failure of the combination processing of the plurality of sets of image data is estimated in the combination imaging mode.

3. The imaging device according to claim 2, wherein:
the controller further includes a combination determination component configured to determine whether the combination processing of the plurality of sets of image data succeeds or fails based on the plurality of sets of image data or image data obtained by combining the plurality of sets of image data.

4. The imaging device according to claim 3, wherein:
the combination determination component is further configured to:
detect at least one edge of the plurality of sets of image data or the edge of image data obtained by combining the plurality of sets of image data, and
determine the success or failure of the combination processing based on the distribution of the at least one edge.

5. The imaging device according to claim 1, wherein:
each set of the plurality of sets of image data are captured using a plurality of exposure times.

6. The imaging device according to claim 5, wherein:
the selected at least one set of image data includes image data captured at the shortest exposure time of the plurality of sets of image data.

7. The imaging device according to claim 5, wherein:
the selected at least one set of image data includes image data captured at the longest exposure time of the plurality of sets of image data.
